(19) United States
(12) Patent Application Publication
(10) Pub. No.: US 2023/0249528 A1
(43) Pub. Date: Aug. 10, 2023

(54) Arrangement for a vehicle roof, method for manufacturing an arrangement for a vehicle roof, vehicle roof, and motor vehicle

(71) Applicant: Webasto SE, Stockdorf (DE)

(72) Inventors: Rudolf WIMMER, Stockdorf (DE); Thomas WILLERER, Stockdorf (DE); Sebastian GATTINGER, Stockdorf (DE); Marcel MARQUARDT, Stockdorf (DE)

(21) Appl. No.: 18/004,816

(22) PCT Filed: Aug. 5, 2021
(86) PCT No.: PCT/EP2021/071889

§ 371 Date: Jan. 9, 2023

(30) Foreign Application Priority Data
Aug. 21, 2020 (DE) 10 2020 121 962.8

(51) Int. Cl. B60J 7/22; B60J 7/00

(52) U.S. Cl. CPC B60J 7/22; B60J 7/0015

(57) ABSTRACT

An arrangement for a vehicle roof has a roof element designed to be coupled to the vehicle roof and to provide a predetermined functionality. The arrangement further has a thread-free film element which is formed by calendering and is coupled to the roof element such that the predetermined functionality is obtained.

### CROSS-REFERENCE TO RELATED APPLICATIONS

This application is a U.S. national phase application filed under 35 U.S.C. § 371 of International Application No. No. PCT/EP2021/071889, filed Aug. 5, 2021, designating the United States, which claims priority from German Patent Application Number DE 10 2020 121 962.8, filed Aug. 21, 2020, which is hereby incorporated herein by reference in its entirety for all purposes.

### FIELD

The invention relates to an arrangement for a vehicle roof and to a vehicle roof and to a motor vehicle having such an arrangement. The invention further relates to a method for manufacturing an arrangement for a vehicle roof.

### BACKGROUND

The prior art discloses arrangements for vehicle roofs which, for example, form a wind deflector. A wind deflector is described in WO 2012/167976 A1, for example. As an alternative or in addition, it is possible to provide an arrangement which forms a darkening device, for example in the form of a roller blind arrangement with a roller blind web. Such a darkening device is used to protect against sunlight under a transparent roof section of the vehicle, which has, for example, a glass panoramic roof or a sliding roof. A roller blind arrangement of this kind is known from EP 2 004 430 B1, for example. In the case of such arrangements, there is a constant effort to enable low-cost manufacture and reliable operation of the arrangement.

### SUMMARY

It is an underlying object of the present invention to provide an arrangement for a vehicle roof which can be manufactured at low cost and, in addition, permits reliable operation. Another underlying object of the present invention is to provide a corresponding manufacturing process for an arrangement for a vehicle roof and a corresponding vehicle roof and motor vehicle.

The respective object is achieved by the features of the respective independent patent claim. Advantageous embodiments are specified in the associated dependent patent claims.

An arrangement according to the invention for a vehicle roof has a roof element configured to be coupled to the vehicle roof and to provide a predetermined functionality. The arrangement further has a thread-free film element which is formed by calendering and is coupled to the roof element, such that the predetermined functionality is obtained.

The described arrangement can be implemented in a low-cost manner, in particular on account of the film element, and moreover permits reliable operation, for example of a wind deflector or a darkening device.

According to a preferred embodiment of the arrangement, the roof element forms a wind deflector and comprises a wind deflector bracket, to which the thread-free film element is coupled. The film element thus forms the wind-deflecting or wind-guiding element. In this case, the arrangement can be transferred from a first, pivoted-in state into a second, pivoted-out state, and a predetermined influence on the flow of the relative wind can be set up.

In connection with the present invention, there is a recognition that, in conventional wind deflectors, a woven fabric or mesh of synthetic fibers is installed, which is cut out of square meter goods and arranged in the wind deflector. Such a mesh or woven fabric has a multiplicity of fibers, which are knotted and/or sewn together and form a multiplicity of knitted honeycomb elements and mesh openings. Such wind deflector meshes are usually attached to associated elements by means of screws, clips or direct overmolding. One problem with such previous designs is the relatively high price of the wind deflector mesh material per square meter. The wind deflector mesh is generally the most expensive component in the assembly of a wind deflector.

By means of the described arrangement and the film element, this cost point can be reduced by targeted material substitution. In particular, the arrangement can form a wind deflector in which a conventional, expensive wind deflector mesh is replaced by a significantly more favorable wind-deflecting or wind-guiding film which, in comparison, costs less than one tenth of what a conventional wind deflector mesh costs. In addition, the film element can provide advantageous air flow properties by, for example, completely deflecting the air flow caused by the relative wind. In comparison, although conventional wind deflector meshes permit a certain flow guidance of a passing wind or air flow, they are themselves still air-permeable, with the result that an air flow cannot be deflected completely.

The film element is manufactured, in particular, from plastic, such as PBT (polybutylene terephthalate), PES (polyethersulfone) or PET (polyethylene terephthalate). As an alternative or in addition, the film element can comprise PE-LD (low-density polyethylene) and/or PP (polypropylene).

Such plastic films can be manufactured at low cost by means of calendering. Here, calendering refers to a manufacturing process which is based on a clearly understandable extrusion process. As a result of the lower-cost manufacturing process, compared with a complex weaving process for previous wind deflector meshes, costs for a wind deflector can thus be significantly reduced.

The film element differs significantly from a conventional wind deflector mesh, inter alia also by its feel and appearance. In particular, the film element is not woven and does not form a textile element. In other words, the film element is free from woven fabric and contains no processed fibers. In comparison with a conventional wind deflector mesh which, as a woven fabric, necessarily has holes in its surface, the film element can have a completely closed surface and can be formed free of holes. Thus, in addition to reduced costs, it is possible to contribute to an improved capacity for guiding an air flow.

If the arrangement is implemented as a wind deflector and is transferred into the second state, in which the wind deflector bracket is raised and the film element is stretched, it is possible, on account of the closed surface of the film element, to set up selective control of the impinging air flow produced during operation of an associated motor vehicle. Alternatively or in addition, however, an embossed pattern or perforations can also be introduced into the film element in a selective manner in order to provide a desired air permeability.

According to a further preferred embodiment of the arrangement, the roof element forms a darkening device and comprises a darkening element, for example in the form of a roller blind or a sliding headliner. The thread-free film element forms, for example, the darkening element or is coupled thereto, thus enabling the arrangement to be transferred from a first, uncovering state into a second, darkening state and predetermined shading for a vehicle interior to be set up.

In particular, the film element can form a roller blind or can form at least one component of a roller blind web which can be wound up and unwound along a pull-out direction. As an alternative or in addition, a darkening device can be provided, in which the film element forms at least one component of a sliding headliner which can be moved along the pull-out direction.

In connection with the present invention, there is a recognition that some conventional shading systems have shading elements with woven fabric and are therefore, inter alia, relatively expensive. For example, a vehicle roof is provided with a panoramic sliding roof which has a conventional shading system with a woven fabric in order to darken the vehicle interior. The fabric is then applied, for example, to a rigid sliding headliner or can be wound up to form a roller blind.

If the fabric is designed as a roller blind which can be wound and unwound, an additional layer, for example of PU (polyurethane), is generally also applied in order to be able to darken the passenger compartment in a stable and reliable manner. Furthermore, metal strips are usually adhesively bonded and/or stitched laterally to such a material for lateral guidance. Such a shading system is relatively cost-intensive on account of the complex manufacturing methods, such as, for example, mesh weaving and subsequent cutting to size, e.g. by means of a laser. Moreover, the attachment of lateral strips, e.g. of metal or plastic, which form guide strips for reliable movement of the shading element, is complicated. This requires, for example, additional working steps, such as adhesive bonding and/or stitching. It may furthermore also be necessary to apply a further layer of darkening material in an additional step.

By means of the described arrangement, it is possible to form a darkening device which enables substitution of previous cut-to-size pieces of material and can contribute to a low-cost and clear structure. In this case, the film element can form the entire darkening element or can form a part thereof. For example, the film element in the form of a roller blind can contribute to a particularly flat and space-saving construction, particularly in the region of the winding shaft, since only one layer of the film element would be wound up there.

The film element can be designed as a continuous, opening-free film or, for example, can form a film perforated by means of a vacuum. In each case, the film element is manufactured by the film calendering process. In this case, it is possible to integrate various further steps, such as the introduction of hole patterns or the formation of a desired surface structure and surface contour. Moreover, the film element can be designed or provided in such a way that it functions like a polarization filter and has, for example, two or more film parts. According to an embodiment of the arrangement, the film element has a plurality of recesses or openings which form an embossed pattern or perforations.

According to a further aspect, a vehicle roof according to the invention for a motor vehicle has at least one embodiment of the above-described arrangement, which is coupled to a roof skin of the vehicle roof.

According to a further aspect, a motor vehicle according to the invention is disclosed which has an embodiment of the above-described vehicle roof which is coupled in a fixed manner to a roof structure of the motor vehicle.

By virtue of the fact that the vehicle roof and the motor vehicle comprise an embodiment of the above-described arrangement, characteristics and features of the arrangement are also disclosed for the vehicle roof and the motor vehicle and vice versa.

A method according to the invention for manufacturing an arrangement for a vehicle roof comprises forming a thread-free film element by means of calendering and providing a roof element which is designed to be coupled to the vehicle roof and to provide a predetermined functionality. The method further comprises coupling the thread-free film element to the roof element, such that the arrangement is formed and set up with the predetermined functionality.

By means of the method described, it is possible, in particular, to form a configuration of the described arrangement which, on account of the specially provided film element, can be implemented at low cost and, in addition, makes possible reliable operation, e.g. of a wind deflector or of a darkening device. The flowable substance forms the raw material from which the film element is to be formed. This can be a plastic, such as PET or PBT, for example. Alternatively, it is also possible to use a plastic which provides a predetermined electrical or light-conducting property.

According to an embodiment of the method, the roof element is provided as a wind deflector and comprises a wind deflector bracket. Accordingly, coupling the thread-free film element to the roof element comprises coupling the film element to the wind deflector bracket, thus enabling the arrangement to be transferred from a first, pivoted-in state to a second, pivoted-out state and a predetermined influence on the flow of relative wind to be set up.

Alternatively, the roof element is provided as a darkening device and comprises a darkening element. Accordingly, coupling the thread-free film element to the roof element comprises coupling the film element to the darkening device, thus enabling the arrangement to be transferred from a first, retracted state into a second, extended state and predetermined shading for a vehicle interior to be set up. In this case, the film element can completely or partially form the darkening element, for example in the case of a darkening device in the form of a roller blind system.

According to an embodiment of the method, the formation of the thread-free film element by means of calendering comprises providing a rolling installation which comprises at least one rolling element having a predetermined surface structure, wherein, in cooperation with a counter-element, the rolling element forms a gap and delimits it in a predetermined manner, and providing a flowable substance having predetermined material properties. Accordingly, the method further comprises passing the provided substance through the gap and forming the film element with a surface structure predetermined by the rolling element and the counter-element. In particular, the method can also comprise introducing a plurality of recesses or openings into the film element, forming an embossed pattern or perforations in or on the film element.

The rolling installation comprises, for example, two steel rolls, one of which forms the above-described counter-element. Alternatively, the counter-element can be provided as a stop or wall in order to delimit the gap in a predetermined manner.

Furthermore, the rolling installation can be temperature-controlled in order to allow reliable shaping of the film element. In particular, a surface structure of the rolling element or of the rolls is predetermined in accordance with a geometry of the film element to be formed. Thus, the roll element has respective grooves on opposite edges, for example, leading to the film element being formed with corresponding thickened portions of the material at these positions. It is thus possible to design the film element as a darkening element with lateral material reinforcements which produce guide strips that are formed integrally with the shading surface arranged between them.

By means of the method described, it is possible, inter alia, to carry out the necessary manufacturing steps in a manufacturing process. Moreover, it is possible to integrate further optional manufacturing steps with little effort. For example, a desired hole pattern can be introduced into the film element in order to achieve a desired high-value appearance. This can also have an advantageous effect on air permeability and acoustics in relation to an impinging air flow, in the event that the film element forms a component of a wind deflector, for example.

In addition, there are extensive possibilities for influencing the properties of the film element on the basis of the very large selection of plastics which can form the flowable substance for the formation of the film element. For example, it is possible to select a plastic which has a low tendency for making a rustling noise in order to contribute to low-noise acoustics during operation of the arrangement.

Furthermore, it is also possible for a lateral cut-to-size piece to be integrated into the manufacturing process by means of a laser. Moreover, it is possible to integrate a lateral reinforcing strip, functioning as a textile module, into the manufacturing process. In this way, a materially bonded connection can be formed between the shading material and the lateral reinforcing strips, and this can have an advantageous effect on the stability of the arrangement in the form of a darkening device. Elaborate and costly adhesive bonding or stitching processes can thus be replaced.

In addition, the method described also makes it possible to replace a relatively expensive PU backing, which is generally designed as a stabilizing layer in the case of a conventional shading system. By means of the method described, there is the possibility of applying or forming a film suitable for darkening in the same process step of calendering. Alternatively or in addition, it is possible to apply or form a relatively thin special film for filtering the light, which provides the function of a polarization filter. A second film interacting with this can then be integrated, for example, in a glass cover panel which is to be installed in the vehicle roof. A significant darkening effect can thus be achieved, e.g. when the roller blind is closed.

In addition, there is also an option of allowing only specifically predetermined light, e.g. spectrally red light, to pass, thus enabling a special light effect to be set up by means of the method described and the arrangement which can be manufactured therewith. A further integration of light effects is also possible by means of an application of optical fibers which are included in the calendering process. For example, acrylic glass or PMMA (polymethylmethacrylate) optical fibers are also processed and integrated or embedded in the film element during the formation of the film element. It is thus possible, for example, to dispense with an expensive process of weaving in optical fibers, as is usually the case with conventional fabrics or mesh.

The method described thus allows, inter alia, the following advantages:
a cost reduction by:
   a very favorable manufacturing process of the film element
   very favorable plastics/raw materials, which can be selected to form the film element
   very high flexibility in the selection of the materials used with regard to the desired application/function (such as UV stabilization by means of additives in the granules)
a number of other possibilities, such as:
   application of, for example, TPE (thermoplastic elastomers)
   additional films that can be introduced at very low cost (e.g. to develop a “blackout function”)
   insertion of PMMA optical fibers/threads, which can be applied to the film element in a materially bonded manner or can be introduced into it; in addition, a hole pattern can be provided in the film element in a matched manner.

### BRIEF DESCRIPTIONS OF THE DRAWINGS

Exemplary embodiments of the invention are explained below with reference to schematic drawings. In the drawings:

FIG. 1 shows a schematic, perspective view of a vehicle roof having an arrangement,

FIGS. 2-3 show an exemplary embodiment of the arrangement for the vehicle roof according to FIG. 1,

FIG. 4 shows a further schematic, perspective view of a vehicle roof with a further exemplary embodiment of the arrangement,

FIG. 5 shows an exemplary embodiment of a fiber-free film element of the arrangement for the vehicle roof according to FIG. 1 or 4, and

FIG. 6 is a flowchart for a method for manufacturing an arrangement for a vehicle roof according to FIG. 1 or 4.

Elements of identical design and function are denoted by the same reference signs throughout the figures. For reasons of clarity, not all the elements illustrated may be denoted by associated reference signs in all the figures.

### DETAILED DESCRIPTION

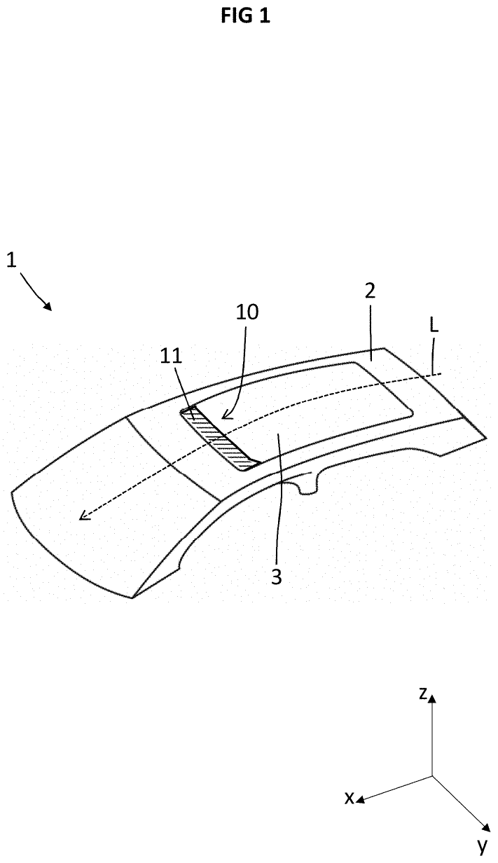

FIG. 1 shows a schematic view of a vehicle roof 1 for a motor vehicle, which has a cover panel system 3. The vehicle roof 1 is coupled in a fixed manner to the rest of the roof structure. The cover panel system 3 is integrated into the vehicle roof 1 and coupled to a roof skin 2 of the vehicle 30 roof 1. The cover panel system 3 comprises, for example, a movable sliding roof cover panel in order to selectively close or at least partially uncover a roof opening in the vehicle roof 1. Alternatively, the cover panel system 3 comprises a transparent roof element, such as a panoramic roof, which is firmly closed. In this case, a stationary transparent roof element is provided.

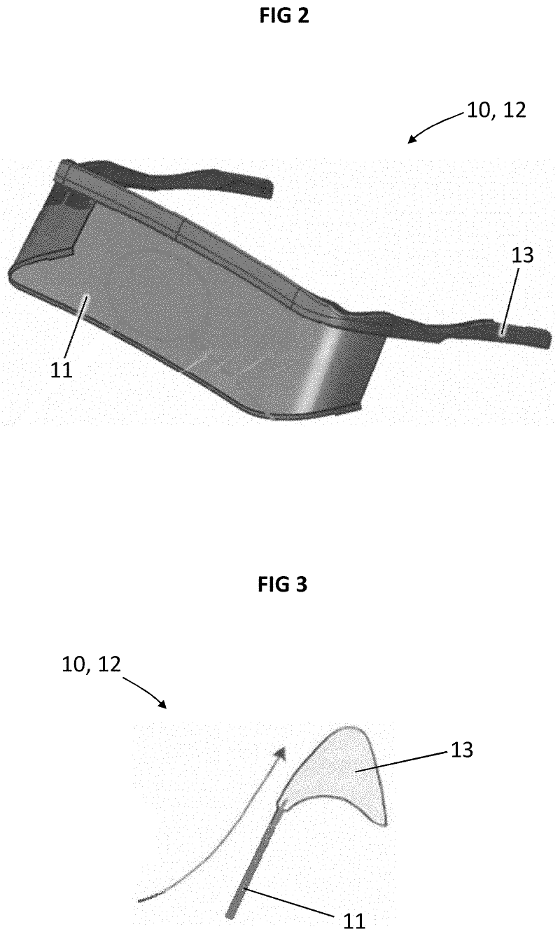

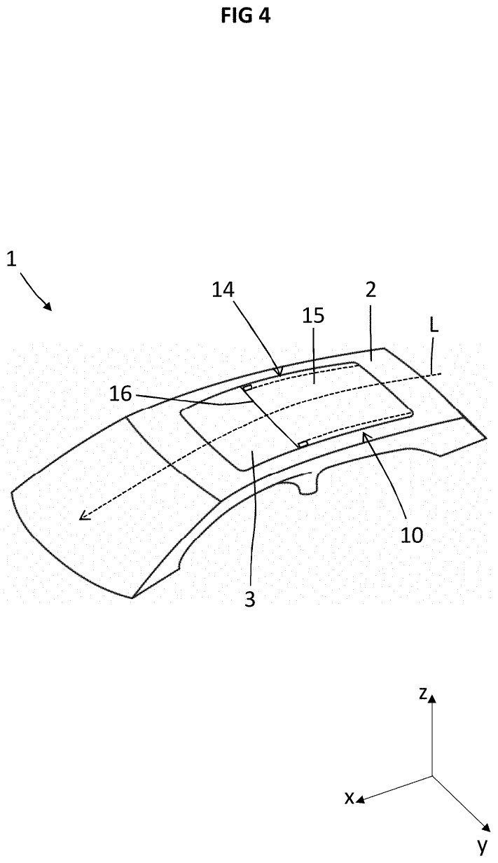

An arrangement 10 is coupled to the vehicle roof 1. As will be explained below with reference to FIGS. 1 to 6, the arrangement 10 can be manufactured at low cost, in particular by virtue of a specially designed film element 11, and furthermore enables reliable operation, e.g. of a wind deflector 12 (see FIGS. 2 and 3) or of a darkening device 14 (see FIG. 4).

The arrangement 10 has a roof element which is embodied as a wind deflector 12 or as a darkening device 14, for example. The roof element 12, 14 is designed to be coupled to the vehicle roof 1 and to provide a predetermined functionality. The arrangement 10 further has the film element 11, which is formed by calendering without threads or woven fabric and is coupled to the roof element 12, 14 such that the predetermined functionality is obtained.

The film element 11 offers a plurality of possible uses and, in addition, enables reliable functionalities of the arrangement 10 for the vehicle roof 1. According to FIGS. 1-3, the film element 11 can form a component of a wind deflector 12. In this case, the film element 11 makes it possible to substitute a conventional woven wind deflector mesh and contributes to a low-cost construction of the wind deflector 12.

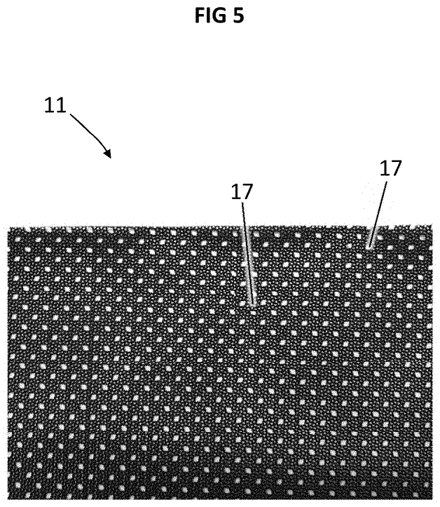

FIG. 2 shows a perspective view of the wind deflector 12, which has the film element 11. In particular, the film element 11 can be of opening-free or continuous design and can thus contribute to particularly reliable guidance of an air flow which results from relative wind during operation of a motor vehicle. For this purpose, the wind deflector 12 is opened and transferred from a first, retracted state into a second, deployed state. This takes place, as a rule, when the roof opening in the vehicle roof 1 is uncovered in order to reduce an unwanted air flow through the uncovered roof opening into the vehicle interior. By means of the continuous film element 11, the impinging air flow can be selectively deflected (see schematic sectional illustration in FIG. 3). Alternatively, however, the film element 11 can also be designed with perforations or an embossed pattern 17 and can have a plurality of openings in order to provide a certain air permeability (see FIG. 5).

FIG. 4 shows another schematic view of the vehicle roof 1 for a motor vehicle which, in contrast to the vehicle roof according to FIG. 1, has the arrangement 10 in the form of a darkening device 14. The darkening device 14 is coupled to the vehicle roof 1 and designed, for example, as a roller blind or sliding headliner system and configured to reduce the incidence of light through the cover panel system 3, if required, by means of a darkening element 15. The darkening element 15 is configured, for example, as a roller blind web or sliding headliner and has an embodiment of the film element 11.

In the case of a roller blind web, the latter can be formed completely by the film element 11, thus enabling a particularly flat and space-saving design of the darkening device 14 to be achieved. The roller blind web or the film element 11 can be wound up and unwound along a pull-out direction L by means of a winding shaft, for example. In the arrangement according to FIGS. 1 and 4, the pull-out direction L also corresponds to a vehicle longitudinal direction of the motor vehicle or of the vehicle roof 1.

FIG. 5 illustrates an exemplary embodiment of the film element 11 which has a plurality of openings in the form of perforations 17 in order to provide a certain air permeability. Such holes can be formed selectively by means of vacuum suction, for example. Alternatively, in a manufacturing process of the film element 11, for example, the holes are formed in a predetermined manner in that, for example, roll elements by means of which the film element 11 is formed have a predetermined surface structure with prongs, teeth or points and corresponding free spaces, with the result that the film element 11 has a correspondingly predetermined structure when it is passed through or guided through between the roll elements. As an alternative to the embodiment shown in FIG. 5, however, the film element 11 can also be designed continuously without holes or openings.

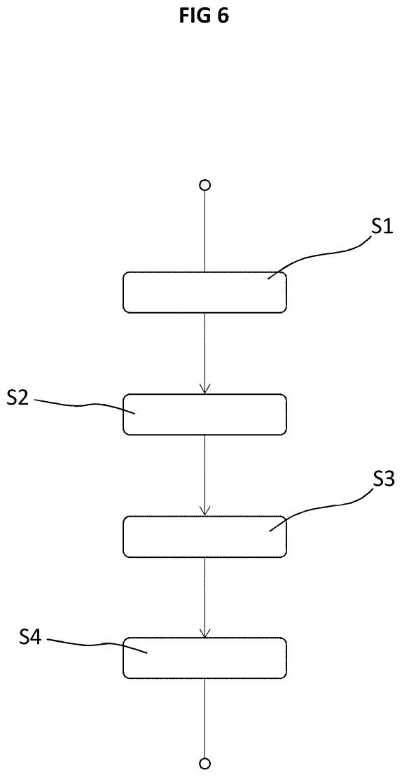

FIG. 6 illustrates a flowchart for a method for manufacturing an embodiment of the arrangement 10 for the vehicle roof 1. In a step S1, it is possible to provide a rolling installation and a flowable or pumpable substance which forms a raw material or starting material of the film element 11. A plastic with predetermined material properties which is to be processed by means of the rolling installation, such as PBT (polybutylene terephthalate) or PET (polyethylene terephthalate), is provided, for example. The rolling installation comprises at least one rolling element having a predetermined surface structure which, in cooperation with a counter-element, in particular a second rolling element, forms a gap and delimits it in a predetermined manner.

In a further step S2, the film element 11 is formed by passing the supplied substance through the gap. In particular, the roll element or elements are temperature-controlled in a predetermined manner and have a predetermined surface structure in order to establish a desired appearance or structure of the film element 11. In this way, an embossed pattern, a logo and/or also openings can be formed on the film element 11 or introduced into the film element 11. Thus, the film element 11 is formed by means of calendering.

In a further step S3, a roof element is then provided for the vehicle roof 1, for example. According to FIGS. 1-3, the roof element can be provided as a wind deflector 12 or as an associated wind deflector bracket 13, to which the film element 11 is to be connected. Alternatively, the roof element can, according to FIG. 4, be provided as a darkening device 14 or as one or more associated darkening components, to which the film element 11 is to be attached. For example, the film element 11, in cooperation with the darkening device 14, is to form a shading element in the form of a roller blind or is to be attached to a sliding headliner. Alternatively, it is also possible to form two or more film elements 11 which are to be coupled to respective roof elements and are to contribute to the construction of a vehicle roof.

In a further step S4, the film element 11 formed in the predetermined manner is coupled, e.g. clamped, adhesively bonded, screwed and/or stitched, to the roof element provided for this purpose. In this way, a configuration of the arrangement 10 can be formed and a predetermined functionality can be set up. In the case of the darkening device 14, the predetermined functionality comprises, in particular, shading or darkening a vehicle interior of the associated motor vehicle as required. In addition, the functionality can also provide an attractive lighting function which can be achieved by means of optical fibers which are processed with the film element 11 when the latter is produced. In this way, it is possible to contribute to a beautiful appearance of the arrangement 10 and to increased comfort of the motor vehicle.

A corresponding increase in comfort can be achieved by a selectively provided embossed pattern or perforations of the film element 11. Such a structure or the introduction of a plurality of depressions, recesses or openings into the film element 11, which form an embossed pattern or perforations 17, can be formed in particular when the raw material of the film element 11 is passed through. Alternatively or in addition, the film element 11 can subsequently be processed and formed with a predetermined structure. For example, openings or holes can be introduced into the film element 11 by means of a laser.

By means of the method described and the described structure of the arrangement 10, the latter can be implemented in a low-cost manner on the basis of the film element 11 and, in addition, makes possible reliable operation of a wind deflector 12, a darkening device 14 and also other arrangements which comprise a roof element and allow interaction with an embodiment of the film element 11 described.

1. An arrangement for a vehicle roof, having:
a roof element designed to be coupled to the vehicle roof and to provide a predetermined functionality, and
a thread-free film element which is formed by calendering and is coupled to the roof element such that the predetermined functionality is obtained.

2. The arrangement according to claim 1, in which the roof element forms a wind deflector and comprises a wind deflector bracket, and in which the thread-free film element is coupled to the wind deflector bracket, thus enabling the arrangement to be transferred from a first, pivoted-in state into a second, pivoted-out state and a predetermined influence on the flow of relative wind to be set up.

3. The arrangement according to claim 1, in which the roof element forms a darkening device and comprises a darkening element, and in which the thread-free film element forms the darkening element or is coupled thereto, thus enabling the arrangement to be transferred from a first, uncovering state into a second, darkening state and predetermined shading for a vehicle interior to be set up.

4. The arrangement according to claim 3, in which the film element forms at least one component of a roller blind web which can be wound up and unwound along a pull-out direction, or in which the film element forms at least one component of a sliding headliner which can be moved along the pull-out direction.

5. The arrangement according to claim 1, in which the film element has a plurality of recesses or openings which form an embossed pattern or perforations.

6. A vehicle roof for a motor vehicle, comprising:
an arrangement according to claim 1, which is coupled to a roof skin of the vehicle roof.

7. A motor vehicle, having:
a vehicle roof according to claim 6, which is coupled in a fixed manner to a roof structure of the motor vehicle.

8. A method for manufacturing an arrangement for a vehicle roof, comprising:
forming a thread-free film element by means of calendering,
providing a roof element designed to be coupled to the vehicle roof and to provide a predetermined functionality, and
coupling the thread-free film element to the roof element, such that the arrangement is formed and set up with the predetermined functionality.

9. The method according to claim 8, in which the roof element is provided as a wind deflector and comprises a wind deflector bracket, and in which coupling the thread-free film element to the roof element comprises:
coupling the thread-free film element to the wind deflector bracket, thus enabling the arrangement to be transferred from a first, pivoted-in state to a second, pivoted-out state and a predetermined influence on the flow of relative wind to be set up.

10. The method according to claim 8, in which the roof element is provided as a darkening device and comprises a darkening element, and in which the coupling of the thread-free film element to the roof element comprises:
coupling the thread-free film element to the darkening device, thus enabling the arrangement to be transferred from a first, retracted state into a second, extended state and predetermined shading for a vehicle interior to be set up.

11. The method according to claim 8, in which the formation of the thread-free film element by means of calendering comprises:
providing a rolling installation which comprises at least one rolling element having a predetermined surface structure, wherein, in cooperation with a counter-element, the rolling element forms a gap and delimits it in a predetermined manner,
providing a flowable substance having predetermined material properties, and
passing the provided substance through the gap and forming the film element with a surface structure predetermined by the rolling element and the counter-element.

12. The method according to claim 8, comprising:
introducing a plurality of recesses or openings into the film element, forming an embossed pattern or perforations.
